(19) United States
(12) Patent Application Publication
(10) Pub. No.: US 2021/0364288 A1
(43) Pub. Date: Nov. 25, 2021

(54) OPTICAL MEASUREMENT AND CALIBRATION METHOD FOR POSE BASED ON THREE LINEAR ARRAY CHARGE COUPLED DEVICES (CCD) ASSISTED BY TWO AREA ARRAY CCDS

(71) Applicant: Harbin Institute of Technology, Harbin (CN)

(72) Inventors: Kai Li, HARBIN (CN); Yinghui Hu, HARBIN (CN); Yongbin Du, HARBIN (CN); Zongze Jiang, HARBIN (CN); Yinghui Zhang, HARBIN (CN); Feng Yuan, HARBIN (CN)

(21) Appl. No.: 17/152,150

(22) Filed: Jan. 19, 2021

(30) Foreign Application Priority Data
May 22, 2020 (CN) 202010443168.5

(51) Int. Cl. G01C 11/00; G01C 25/00

(52) U.S. Cl. CPC G01C 11/00; G01C 25/00

(57) ABSTRACT

An optical measurement and calibration method for a pose based on three linear array charge coupled devices (CCD) assisted by two area array CCDs includes the following steps: step 1: preparing devices, and determining cooperative targets, namely three red light-emitting diode (LED) light dots; step 2: arranging measuring devices; step 3: configuring a cylindrical lens of a linear array CCD camera with a cylindrical mirror and an optical filter; and step 4: measuring through a fast capture process, a coarse adjustment calculation process, a fine adjustment calculation process, and a calibration process till coordinates are obtained by means of a fine adjustment. According to the present disclosure, an optical lens based on a telecentric optical path in an image space can fulfill a large field of view (FOV), an extended depth of field (DOF), and low distortion of a system.

### CROSS-REFERENCE TO RELATED APPLICATIONS

The present application claims priority to the Chinese Patent Application CN202010443168.5, filed to the China National Intellectual Property Administration (CNIPA) on May 22, 2020 and entitled “OPTICAL MEASUREMENT AND CALIBRATION METHOD FOR POSE BASED ON THREE LINEAR ARRAY CHARGE COUPLED DEVICES (CCD) ASSISTED BY TWO AREA ARRAY CCDS”, which is incorporated herein by reference in its entirety.

### TECHNICAL FIELD

The present disclosure relates to the technical field of data measurement and data calibration, in particular to an optical measurement and calibration method for a pose based on three linear array charge coupled devices (CCD) assisted by two area array CCDs.

### BACKGROUND

Currently, it is common to measure the poses of flying objects based on CCD cameras according to a geometric optical measurement principle by means of vision-based measurement technologies such as forward rendezvous and docking and coordinate transformation. In these technologies, the CCD cameras, namely measuring devices, have simple structures, no contact, and high accuracy and timeliness. Compared with area array CCDs, linear array CCDs have higher resolution and sampling speeds, and smaller data volumes, so as to facilitate real-time pose measurement. Therefore, a measurement system composed of a plurality of linear array CCDs and a plurality of area array CCDs has a simple approach, high accuracy, and portability. This kind of system plays an important role in the field of measurement of poses of objects in a large field of view (FOV) and a non-contact space as well as calibration of coordinates of the objects.

However, most measurement technologies based on the linear array CCDs adopt linear scanning and are seldom used to measure the poses separately. An extended depth of field (DOF) is required by measurement of the poses of the objects during flying. Accompanied with development of technologies, degrees of integration, materials, and control circuits of linear array CCD cameras and area array CCD cameras, resolution, frame rates, saturation, exposure times, and other parameters thereof are greatly optimized and improved. Therefore, optical system design, lenses, machining, and device arrangements and adjustments of the measurement system need to be increasingly improved. The linear array CCDs only have unidirectional pixels and thus cannot use, like the area array CCDs, general lenses formed by common spherical mirrors to measure coordinates of space targets. However, cylindrical mirrors capable of points imaging into lines imaging can effectively reduce spherical aberration and chromatic aberration, and is especially suitable for measuring space positions of the objects during flying in combination with the linear array CCDs.

### SUMMARY

A linear array CCD has high one-dimensional resolution and thus facilitates improvement on measurement accuracy. An area array CCD has a two-dimensional FOV and thus fulfills fast imaging and facilitates capture of a dynamic target. The present disclosure provides an optical measurement and calibration method for a pose based on linear array CCDs assisted by two area array CCDs. An optical lens based on telecentric optical path in an image space can fulfill a large FOV, an extended DOF, and low distortion of a system, and a measurement system is established by means of three linear array CCDs assisted by two area array CCDs; in this way, a new measurement method implemented by using such system can realize high-accuracy measurement of a pose of an object as well as calibration of a coordinate of the object.

The present disclosure adopts the following technical solution:

An optical measurement method for a pose based on three linear array CCDs assisted by two area array CCDs includes the following steps:

step 1: preparing devices, and determining cooperative targets, namely three red light-emitting diode (LED) light dots;

step 2: arranging measuring devices, where a linear array CCD1 and a linear array CCD3 on two sides are horizontally arranged relative to the cooperative targets, a linear array CCD2 in the middle is vertically arranged relative to the cooperative targets, an area array CCD1 and an area array CCD2 are alternately spaced from three linear array CCDs, and five cameras in the same horizontal line are equally spaced from one another;

step 3: configuring a cylindrical lens of each linear array CCD camera with seven cylindrical mirrors and one optical filter of 635 nm; and

step 4: measuring through a fast capture process, a coarse adjustment calculation process, a fine adjustment calculation process, and a calibration process till coordinates are obtained by means of a fine adjustment.

Further, the devices in step 1 include linear array CCD cameras, lenses of the linear array CCD cameras, area array CCD cameras, and lenses of the area array CCD cameras.

Further, the measuring devices in step 2 are arranged as follows: cylindrical lenses on two sides are perpendicular to the linear array CCD1 and the linear array CCD3, and a cylindrical lens in the middle is horizontal to the linear array CCD2. Linear images, formed via the cylindrical lenses, of LED light dots perpendicularly intersect with the linear array CCDs; planes formed by the light dots and the linear images intersect with the linear array CCDs, and junctions between the planes and the linear array CCDs are regarded as image points. Because the linear images, formed via the cylindrical lenses, of the light dots respectively perpendicularly intersect with the three linear array CCDs, three equations of the planes can be obtained, and junctions of the three planes are regarded as the LED light dots. Spatial coordinates of the light dots can be solved by means of a simultaneous equation composed of the three equations of the planes; and in this way, the spatial coordinates of landmark light dots can be solved as r₁(xₗ₁, yₗ₁, zₗ₁), r₂(xₗ₂, yₗ₂, zₗ₂), r₃(xₗ₃, yₗ₃, zₗ₃) by means of the linear array CCDs.

Further, the cylindrical lens in step 3 is configured as follows: the three red LED light dots serve as the cooperative targets; in view of this, a red optical filter is additionally arranged on the last cylindrical mirror of the lens of each linear array CCD camera; and a telecentric optical path in an image space is designed to make energy of central converged light spots within a DOF unchanged in a direction perpendicular to an optical axis, so as to eliminate a measurement error caused by a change to object distances of the light spots.

Further, the fast capture process in step 4 particularly includes: setting two area array CCD cameras with parameters calibrated previously to be in a burst mode to fast capture three target light dots in a wide FOV in a case where gain, saturability, an exposure time, and other parameters are completely adjusted.

Further, the coarse adjustment calculation process in step 4 particularly includes: acquiring coordinates r₁′(xₗ₁, yₗ₁, zₗ₁), r₂′(xₗ₂, yₗ₂, zₗ₂), r₃′(xₗ₃, yₗ₃, zₗ₃) of the three target light dots by means of a coarse adjustment according to a binocular vision measurement principle.

Further, the fine adjustment calculation process in step 4 particularly includes: turning on the three linear array CCDs to obtain linear light spots on the three linear array CCDs.

Further, the calibration process in step 4 particularly includes:

step 4.1: selecting a parameter where ∀ε [symbol] k, where δx=|xₗᵢ−xₘᵢ|≤ε, δy=yₗᵢ−yₘᵢ|≤ε, δz=|zₗᵢ−zₘᵢ|≤ε, a value of k is determined by the resolution and calibration condition of the cameras, and xₘᵢ, yₘᵢ, and zₘᵢ represent coordinates of the light spots calibrated by a coordinate measuring machine;

step 4.2: in a case where a spatial distance between every two adjacent light spots is unchanged, substituting δx, δy, and δz as parameters into the simultaneous equation composed of the three equations of the planes to obtain the spatial coordinates r₁(xₗ₁, yₗ₁, zₗ₁), r₂(xₗ₂, yₗ₂, zₗ₂), r₃(xₗ₃, yₗ₃, zₗ₃) of the landmark light dots solved by means of the linear array CCDs, where the distance between every two adjacent coordinates is respectively denoted by l₁₂, l₁₃, l₂₃; and

step 4.3: if the spatial coordinates, obtained in step 4.2, of the landmark light dots are identical to the coordinates calibrated by the coordinate measuring machine, stopping the calibration; and otherwise repeating step 4.1 to step 4.2 till the coordinates are obtained by means of the fine adjustment.

The present disclosure has the following beneficial effects:

1. The telecentric optical path in the image space, which is configured by the seven cylindrical mirrors and the red optical filter, effectively eliminates aberration, and reduces distortion. A result shows that the lens distortion is less than 0.05%, and the DOF can reach 1.5 m. The telecentric optical path in the image space can be used together with the linear array CCDs to fulfill high-accuracy testing.
2. The lens of each linear array CCD cameras has a relative aperture D/f=1/4 and thus has an entrance pupil size D of 90.04/4=22.5 mm; an optical material in the lens has a central thickness of 4 cm, and transmittance of the optical material is set as τ=0.999; if the lens is configured by eight lenses, transmittance of a film-coated surface is 99.5%; and if transmittance of the optical filter is 80%, transmittance T of the lens is 73.5%.
3. In terms of data obtained from distortion testing, the lens distortion is less than 0.1% within a range of 1 m×1 m, and overall distortion is less than 0.3% within the range of 1 m×1 m, that is, distortion of an FOV at the center of the lenses is less than that of an FOV at the edge of the lenses; and furthermore, measurement accuracy can be further improved by means of the calibration in use.

### BRIEF DESCRIPTION OF DRAWINGS

FIG. 1 is a schematic diagram of a measurement system formed by three linear array CCDs assisted by two area array CCDs of the present disclosure;

FIG. 2 is a structural diagram of an optical system of a cylindrical lens of the present disclosure; and

FIG. 3 is a diagram illustrating a binocular vision measurement principle.

### DETAILED DESCRIPTION

The technical solutions of the embodiments of the present disclosure are clearly and completely described below with reference to the accompanying drawings. Apparently, the described embodiments are only illustrative of the present disclosure. All other embodiments obtained by those ordinarily skilled in the art based on the embodiments of the present disclosure without creative efforts should also fall within the protection scope of the present disclosure.

### Embodiment 1

An optical measurement method for a pose based on three linear array CCDs assisted by two area array CCDs includes the following steps:

Step 1: prepare devices, and determine cooperative targets, namely three red LED light dots;

Step 2: arrange measuring devices, where a linear array CCD1 and a linear array CCD3 are horizontally arranged on two sides, a linear array CCD2 is vertically arranged in the middle, an area array CCD1 and an area array CCD2 are alternately spaced from three linear array CCDs, and five cameras in the same horizontal line are equally spaced from one another;

Step 3: configure a cylindrical lens of each linear array CCD camera with seven cylindrical mirrors and one optical filter of 635 nm; and

Step 4: measure through a fast capture process, a coarse adjustment calculation process, a fine adjustment calculation process, and a calibration process till coordinates are obtained by means of a fine adjustment.

Further, the devices in step 1 include linear array CCD cameras, lenses of the linear array CCD cameras, area array CCD cameras, and lenses of the area array CCD cameras, where each linear array CCD camera adopts a linear array CCD S1-07K60M-CL produced by Tianjin Auto-Measurements & Vision Technology Co., Ltd. and achieves a pixel value of 7450, a pixel dimension of 4.7 μm×4.7 μm, and a maximum frame rate of 7.8 KHz;

The lens of each linear array CCD camera takes red light of 635±15 nm as an operation section and achieves a 19° angle of a full FOV and a focal length of 90.04 mm;

Each area array CCD cameras adopts an area array CCD DH-HV1302UM produced by Beijing DAHENG New Epoch Technology Inc. and achieves resolution of 1280×1024, an optical dimension of 1/1.8 inches, a pixel dimension of 5.2 μm×5.2 μm, analog-digital conversion accuracy of 10 bits, a pixel depth of 8 bits, and frame rates of SXGA (1280×1024):15 frames/s, VGA:25 frames/s, and CIF:40 frames/s; and

The lens of each area array CCD camera is of a model of TV LENS and achieves a focal length of f=50 mm, and a maximum aperture value of 1.4.

Further, the measuring devices in step 2 are arranged as follows: cylindrical lenses on two sides are perpendicular to the linear array CCD1 and the linear array CCD3, and a cylindrical lens in the middle is horizontal to the linear array CCD2. Linear images, formed via the cylindrical lenses, of LED light dots perpendicularly intersect with the linear array CCDs; planes formed by the light dots and the linear images intersect with the linear array CCDs, and junctions between the planes and the linear array CCDs are regarded as image points. Because the linear images, formed via the cylindrical lenses, of the light dots respectively perpendicularly intersect with the three linear array CCDs, three equations of the planes can be obtained, and junctions of the three planes are regarded as the LED light dots. Spatial coordinates of the light dots can be solved by means of a simultaneous equation composed of the three equations of the planes; and in this way, the spatial coordinates of landmark light dots can be solved as r₁(xₗ₁, yₗ₁, zₗ₁), r₂(xₗ₂, yₗ₂, zₗ₂), r₃(xₗ₃, yₗ₃, zₗ₃) by means of the linear array CCDs.

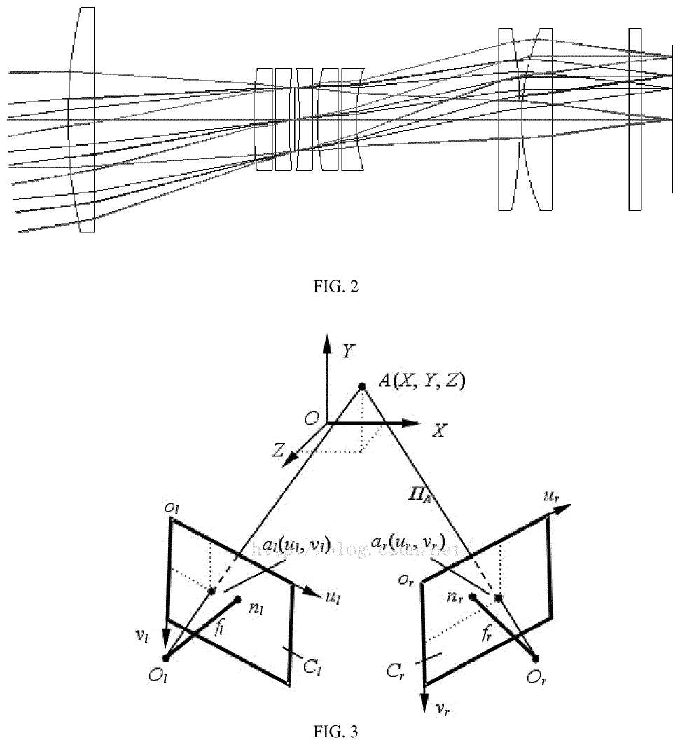

Further, the cylindrical lens in step 3 is configured as follows: because the three red LED light dots serve as the cooperative targets, a red optical filter is additionally arranged on the last cylindrical mirror of the lens of each linear array CCD camera to lower the influence of stray light; and in this way, chromatic aberration is furthest reduced. To make sure that light spots, received by the linear array CCDs, in the full FOV are as small as possible, converged light spots in the full FOV need to be overall adjusted in size; and in view of this, a telecentric optical path in an image space is designed to make energy of central converged light spots within a DOF unchanged in a direction perpendicular to an optical axis, so as to eliminate a measurement error caused by a change to object distances of the light spots. The optical path is shown in FIG. 2.

Further, the fast capture process in step 4 particularly includes: set two area array CCD cameras with parameters calibrated previously to be in a burst mode to fast capture three target light dots in a wide FOV in a case where gain, saturability, an exposure time, and other parameters are completely pre-adjusted.

Further, the coarse adjustment calculation process in step 4 particularly includes: acquire coordinates r₁′(xₗ₁, yₗ₁, zₗ₁), r₂′(xₗ₂, yₗ₂, zₗ₂), r₃′(xₗ₃, yₗ₃, zₗ₃) of the three target light dots by means of a coarse adjustment according to a binocular vision measurement principle.

Further, the fine adjustment calculation process in step 4 particularly includes: turn on the three linear array CCDs to obtain linear light spots on the three linear array CCDs.

Further, the calibration process in step 4 particularly includes:

Step 4.1: select a small parameter, ∀ε [symbol] k, where δx=|xₗᵢ−xₘᵢ|≤ε, δy=yₗᵢ−yₘᵢ|≤ε, δz=|zₗᵢ−zₘᵢ|≤ε, a value of k is determined by the resolution and calibration condition of the cameras, and xₘᵢ, yₘᵢ, and zₘᵢ represent coordinates of the light spots calibrated by a coordinate measuring machine; and

Moreover, the value of k is determined based on measurement accuracy of a final pose as well as limitation to a vision measuring system; the measurement accuracy of the pose is typically defined by repeated positioning accuracy and location positioning accuracy, and its unit is a dimension of a geometric parameter; a large value of k is selected as an initial value (10 times of an accuracy index can be set in most cases), measurement and calibration are carried out according to the steps of the present disclosure, and once a measurement error E of a measured position is less than the value of k, a second iteration is carried out until accuracy required by the system is achieved; a real scale parameter of pixels of the cameras corresponding to a change to an actual pose will be obtained according to calibration results based on internal and external parameters; moreover, the scale parameter may be a limit value of the accuracy; and therefore the value of k must be greater than or equal to this limit value; in conclusion, a constraint on k from a maximum value to a minimum value can be fulfilled;

Step 4.2: in a case where a spatial distance between every two adjacent light spots is unchanged, substituting δx, δy, and δz as parameters into the simultaneous equation composed of the three equations of the planes to obtain the spatial coordinates r₁(xₗ₁, yₗ₁, zₗ₁), r₂(xₗ₂, yₗ₂, zₗ₂), r₃(xₗ₃, yₗ₃, zₗ₃) of the landmark light dots solved by means of the linear array CCDs, where the distance between every two adjacent coordinates is respectively denoted by l₁₂, l₁₃, l₂₃; and

Step 4.3: if the spatial coordinates, obtained in step 4.2, of the landmark light dots are identical to the coordinates calibrated by the coordinate measuring machine (the order of magnitude of the difference of position coordinates is lower than the accuracy index), stop the calibration; and otherwise repeat step 4.1 to step 4.2 till the coordinates are obtained by means of the fine adjustment.

### Embodiment 2

The measuring devices are required to be arranged as follows:

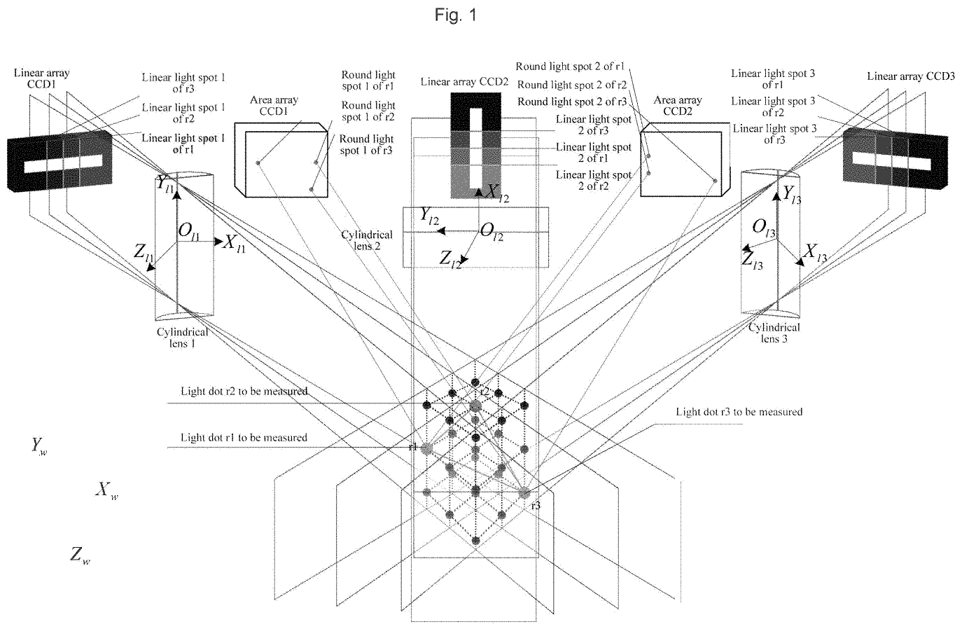

Three linear array CCD cameras are alternately and equally spaced from two area array CCD cameras, and a line of the optical axis is horizontal to a ground level, as shown in FIG. 1;

The cylindrical lenses of the leftmost linear array CCD camera and the rightmost linear array CCD camera are vertically arranged, and the cylindrical lens of the linear array CCD camera in the middle is horizontally arranged, as shown in FIG. 1;

The distance between the linear array CCD cameras and the cylindrical lenses is conform to a focal length of the cylindrical mirrors;

The distance between the measured triangular target, namely the light spots, and each measuring device is 1-4 m; and a height difference in the horizontal direction does not exceed a FOV for capturing the light spots by the area array CCD cameras, that is, f/v=D/V, and f/h=D/H (f represents focal lengths of the lenses, v and h represent dimensions of a focal plane of each CCD in horizontal and vertical directions, D represents the distance between the lenses to the targets, and V and H represent the distance of the full FOV in the horizontal and vertical directions);

The measured target is required to be three vertices forming a right triangle having a length of 20 cm and a 30° angle, and the three vertices are required to be located within the same plane. Particularly, targets with other dimensions can be calculated according to a formula for calculating the FOV.

An algorithm for solving positions of the three light spots, namely the cooperative targets, in step 1 is as follows:

In a world coordinate system, images points aₗ(uₗ, vₗ) and aᵣ(uᵣ, vᵣ) of a point A(X, Y, Z) on imaging planes Cₗ and Cᵣ of the leftmost linear array CCD camera and the rightmost linear array CCD camera are regarded as images of the same object point A in a world space and are called “conjugate points”. In this way, lines respectively connecting the two conjugate points to optical centers Oₗ and Oᵣ of the cameras respectively corresponding to the conjugate points are regarded as projection lines aₗOₗ and aᵣOᵣ, and a junction between the lines is the object point A(X, Y, Z). Coordinates of images of the light spots captured by the area array CCDs with parameters calibrated previously are brought into a formula for an algorithm to obtain the coordinates of the target light dots in the world coordinate system in a coarse pointing mode, as shown in FIG. 3.

A method for calibrating the positions of the light dots, namely the cooperative targets, in step 1 includes:

Set the small parameter E to conform to a difference between the coordinates, obtained by means of the coarse adjustment, of the light dots and the coordinates calibrated by the coordinate measuring machine;

Substitute the difference as a parameter into a formula for calculating the coordinates of the light dots based on the linear array CCDs to obtain an initial value of the coordinates obtained by means of the fine adjustment;

Compare the initial value with the coordinates calibrated by the coordinate measuring machine; if the initial value is consistent with the coordinates calibrated by the coordinate measuring machine, stopping the calibration; and otherwise continuously reduce the small parameter E till required accuracy is achieved to obtain the final coordinates acquired by means of the fine adjustment.

A landmark light dot is a pose identifier (a theoretical true value) of an object to be measured, a target light dot is a pose identifier (a measured value) obtained by means of actual measurement; and due to an error in the actual measurement, the theoretical true value is defined as the landmark light dot, and the measured value is defined as the target light dot.

What is claimed is:

1. An optical measurement and calibration method for a pose based on three linear array charge coupled devices (CCD) assisted by two area array CCDs, comprising the following steps:
step 1: preparing devices, and determining cooperative targets, namely three red light-emitting diode (LED) light dots;
step 2: arranging measuring devices, wherein a linear array CCD1 and a linear array CCD3 on two sides are horizontally arranged relative to the cooperative targets, a linear array CCD2 in the middle is vertically arranged relative to the cooperative targets, an area array CCD1 and an area array CCD2 are alternately spaced from three linear array CCDs, and five cameras in a same horizontal line are equally spaced from one another;
step 3: configuring a cylindrical lens of each said linear array CCD camera with a cylindrical mirror and an optical filter; and
step 4: measuring and calibrating through a fast capture process, a coarse adjustment calculation process, a fine adjustment calculation process, and a calibration process till coordinates are obtained by means of a fine adjustment.

2. The optical measurement and calibration method for a pose based on three linear array CCDs assisted by two area array CCDs according to claim 1, wherein the devices in step 1 comprise linear array CCD cameras, lenses of the linear array CCD cameras, area array CCD cameras, and lenses of the area array CCD cameras.

3. The optical measurement and calibration method for a pose based on three linear array CCDs assisted by two area array CCDs according to claim 1, wherein the measuring devices in step 2 are arranged as follows: cylindrical lenses on two sides are perpendicular to the linear array CCD1 and the linear array CCD3, and a cylindrical lens in the middle is horizontal to the linear array CCD2; linear images, formed via the cylindrical lenses, of the LED light dots perpendicularly intersect with the linear array CCDs; planes formed by the light dots and the linear images intersect with the linear array CCDs, and junctions between the planes and the linear array CCDs are regarded as image points; because the linear images, formed via the cylindrical lenses, of the light dots respectively perpendicularly intersect with the three linear array CCDs, three equations of landmark planes can be obtained, and junctions of the three planes are regarded as the LED light dots; spatial coordinates of the light dots can be solved by means of a simultaneous equation composed of the three equations of the planes; and in this way, the spatial coordinates of three landmark light dots can be solved as r₁(xₗ₁, yₗ₁, zₗ₁), r₂(xₗ₂, yₗ₂, zₗ₂), r₃(xₗ₃, yₗ₃, zₗ₃) by means of the linear array CCDs.

4. The optical measurement and calibration method for a pose based on three linear array CCDs assisted by two area array CCDs according to claim 1, wherein the cylindrical lens in step 3 is configured as follows: the lens of each said linear array CCD camera is configured with seven cylindrical mirrors and one optical filter of 635 nm; the three red LED light dots serve as the cooperative targets; in view of this, a red optical filter is additionally arranged on the last cylindrical mirror of the lens of the said linear array CCD camera; and a telecentric optical path in an image space is designed to make energy of central converged light spots within a depth of field (DOF) unchanged in a direction perpendicular to an optical axis, so as to eliminate a measurement error caused by a change to object distances of the light spots.

5. The optical measurement and calibration method for a pose based on three linear array CCDs assisted by two area array CCDs according to claim 1, wherein the fast capture process in step 4 particularly comprises: setting two area array CCD cameras with parameters calibrated previously to be in a burst mode to fast capture three target light dots in a wide field of view (FOV) in a case where gain, saturability, and an exposure time are completely pre-adjusted.

6. The optical measurement and calibration method for a pose based on three linear array CCDs assisted by two area array CCDs according to claim 1, wherein the coarse adjustment calculation process in step 4 particularly comprises: acquiring coordinates r₁′(xₗ₁, yₗ₁, zₗ₁), r₂′(xₗ₂, yₗ₂, zₗ₂), r₃′(xₗ₃, yₗ₃, zₗ₃) of three target light dots by means of a coarse adjustment according to a binocular vision measurement principle.

7. The optical measurement and calibration method for a pose based on three linear array CCDs assisted by two area array CCDs according to claim 1, wherein the fine adjustment calculation process in step 4 particularly comprises: turning on the three linear array CCDs to obtain linear light spots on the three linear array CCDs.

8. The optical measurement and calibration method for a pose based on three linear array CCDs assisted by two area array CCDs according to claim 1, wherein the calibration process in step 4 particularly comprises:
step 4.1: selecting a parameter ∀ε≤k, where δx=|xₗᵢ−xₘᵢ|≤ε, δy=yₗᵢ−yₘᵢ|≤ε, δz=|zₗᵢ−zₘᵢ|≤ε, i=1, 2, 3 . . . ; a value of k is determined by resolution and a calibration condition of the cameras, and xₘᵢ, yₘᵢ, and zₘᵢ represent coordinates of three landmark light spots calibrated by a coordinate measuring machine;
step 4.2: in a case where a spatial distance between every two adjacent light spots is unchanged, substituting δx, δy, and δz as parameters into a simultaneous equation composed of three equations of planes to obtain spatial coordinates r₁(xₗ₁, yₗ₁, zₗ₁), r₂(xₗ₂, yₗ₂, zₗ₂), r₃(xₗ₃, yₗ₃, zₗ₃) of the landmark light dots solved by means of the linear array CCDs, wherein a distance between every two adjacent coordinates is respectively denoted by l₁₂, l₁₃, l₂₃; and
step 4.3: if the spatial coordinates, obtained in step 4.2, of the landmark light dots are identical to the coordinates calibrated by the coordinate measuring machine, stopping calibration; and otherwise repeating step 4.1 to step 4.2 till the coordinates are obtained by means of a fine adjustment.
